(19) United States
(12) Patent Application Publication
(10) Pub. No.: US 2025/0244494 A1
(43) Pub. Date: Jul. 31, 2025

(54) Vugular Property Modeling using Geologically High-Resolution Machine Learning

(71) Applicant: Saudi Arabian Oil Company, Dhahran (SA)

(72) Inventor: Adam Danur Zeiza, Dhahran (SA)

(21) Appl. No.: 18/428,404

(22) Filed: Jan. 31, 2024

(51) Int. Cl. G01V 1/30; G01V 1/34

(52) U.S. Cl. CPC G01V 1/306; G01V 1/307; G01V 1/345

(57) ABSTRACT

A computer implemented method that enables vugular property modeling using geologically high-resolution machine learning is described. The method includes obtaining multi-disciplinary data associated with a reservoir and determining seismic attributes from the multi-disciplinary data. The method includes transforming the seismic attributes into 3D geocellular properties and estimating a high-resolution 3D acoustic impedance volume and bulk density volume using a first trained machine learning model. A second trained machine learning model predicts 3D vugular geobodies using the estimated high-resolution 3D acoustic impedance and bulk density volumes.

### TECHNICAL FIELD

This disclosure relates generally to vugular property modeling using geologically high-resolution machine learning.

### BACKGROUND

Stratigraphic feature prediction using machine learning is often geologically unrealistic and inaccurate. Traditional predictions include randomly scattered data without any geological meaning due to differences in scale amongst the seismic data and well data.

### BRIEF DESCRIPTION OF DRAWINGS

FIG. 1 shows three dimensional (3D) vugular property modeling using a geologically high-resolution machine learning workflow.

FIG. 2 shows 3D vugular property modeling with derived high resolution 3D properties using a geologically high-resolution machine learning workflow.

FIG. 3 is a process flow diagram of a process that enables vugular property modeling using geologically high-resolution machine learning.

FIG. 4 is a rendering of 3D volumes including 3D vugular geobodies.

FIG. 5 illustrates hydrocarbon production operations that include both one or more field operations and one or more computational operations, which exchange information and control exploration for the production of hydrocarbons.

FIG. 6 is a schematic illustration of an example controller (or control system) that enables property modeling using geologically high-resolution machine learning.

### DETAILED DESCRIPTION

A geologically high-resolution machine learning (GHREM) workflow that enables the generation of geologically sound high-resolution 3D property volumes is described. The workflow ensures the geological consistency of machine learning predictions. In some embodiments, the GHREM workflow is utilized to predict a three dimensional (3D) distribution of a vugular pore system in a carbonate reservoir by corroborating multi-disciplinary data. In examples, multi-disciplinary data includes well-logs, one dimensional (1D) discrete vugular flags, seismic attributes, and high-resolution 3D property volumes (e.g., acoustic impedance and density). The present systems and techniques bridge gaps between seismic data (often captured at a large scale, with low resolution) and well data (often captured at a high resolution at a small scale). Intermediate geologically high-resolution 3D properties such as high-resolution acoustic impedance and high-resolution bulk density properties, improve accuracy and enable geologically realistic vugular geobody spatial and temporal distributions. The geologically realistic vugular geobodies yield more accurate reservoir quality predictions and volume estimations in vuggy carbonate reservoirs.

Some advantages of the present techniques include an improvement to the accuracy of 3D geological modeling by minimizing the effect of scale on the integration of multiple seismic attributes in view of vugular property distributions within carbonate reservoirs. Using the present techniques, different scales of data, such as the larger scale seismic data and higher resolution well data (e.g., such as well logs and other well-based interpretations) are accurately linked to subsurface locations, enabling the identification and monitoring of subsurface features, and accurate more efficient forecasting and production of hydrocarbons. Moreover, the accurate 3D models are used to guide drilling operations and other oil and gas functions.

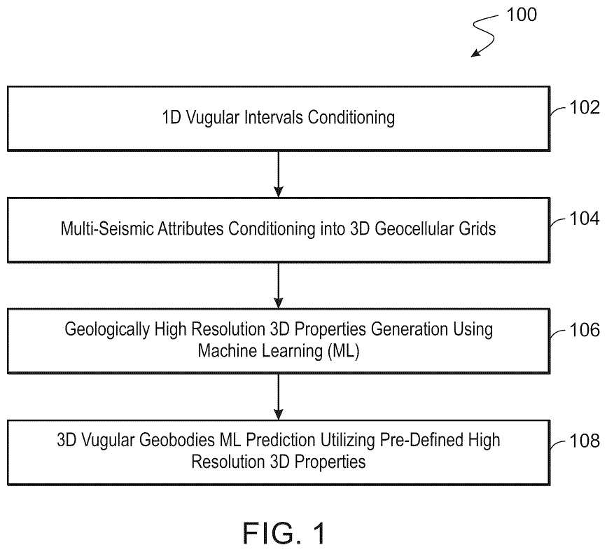

FIG. 1 shows three dimensional (3D) vugular property modeling using a geologically high-resolution machine learning workflow 100. The first stage of the GHREM workflow 100 generates high-resolution 3D properties. In some embodiments, the high-resolution 3D properties are generated by a first machine learning model trained to output the high-resolution 3D properties in response to conditioned multi-seismic attributes as input. The second stage of the GHREM workflow generates 3D vugular geobody predictions using the pre-defined high-resolution 3D properties obtained from the first stage.

At block 102, 1D vugular interval conditioning is performed. 1D vugular interval conditioning involves conversions of discrete vugular flags into a continuous log domain. In examples, vugular intervals are captured from datasets of various scales, such as geoscience and reservoir engineering data. Vugular intervals can be represented at different scales of pore size ranging from millimeters to multi-meters. In some embodiments, the continuous vugular logs are also resampled into 0.2 ft resolution to increase the number of samples for more accurate machine learning predictions. In examples, vugular flag logs contain depth and vug index information. In a vugular flag log, intervals with vug are coded with ‘1’ whereas intervals without vug are coded with ‘0.’

At block 104, multiple seismic attributes are conditioned into geocellular grids. The multiple seismic attributes are generated from multi-disciplinary data, and transformed into 3D gridded data. In examples, 3D gridded data includes cells that correspond to respective locations and are associated with at least one seismic attribute value. A 3D model of the subsurface is created by evaluating the at least one seismic attribute associated with each cell and modifying or retaining the attribute based on a predetermined series of rules. In examples, the at least one seismic attribute associated with each cell is determined on a cell-by-cell basis, where calculations for each cell use the attribute value of the respective cell, the manipulation that is being applied, and other cell locations to include in the calculations. In some embodiments, the 3D gridded data is generated from the multi-disciplinary data using at least one trained machine learning model.

In examples, multi-disciplinary data refers to information about the Earth's subsurface based on data captured both before and during drilling. The data is captured at a variety of scales, from regional (tens to hundreds of miles) to microscopic (such as tiny grains and cracks in the rocks being drilled). In examples, at least some of the data is acquired in earlier exploration efforts and used to determine seismic attributes.

Multiple seismic attributes are generated from the multi-disciplinary data. The seismic attributes have known correlations to vugular property geobodies. The multiple seismic attributes, include, for example, acoustic impedance, quadrature amplitude, root mean square (RMS) amplitude, variance, frequency, envelope and spectrally decomposition.

Quadrature attribute is generated by performing a 90° phase rotation from an original seismic trace. It represents reservoir properties within a stratigraphic interval. In examples, higher quadrature amplitude values correlate with more porous stratigraphic layers. Quadrature can be incorporated in the second machine learning process to predict vugular geobodies.

Acoustic impedance attributes are generated using inversion algorithms. Acoustic impedance attributes are used to represent reservoir properties within stratigraphic layers. In examples, acoustic impedance attributes are calculated from seismic-based density and velocity, which can be correlated to well-log based density and velocity. More porous rocks, such as the vugular geobodies, are related to lower impedance values (e.g., lower density and lower seismic velocity). In some embodiments, the acoustic impedance attribute is used to estimate the high-resolution 3D acoustic impedance property using a first trained machine learning model. The This is performed along with the other seismic attributes as input data, during the first machine learning process.

Root mean square (RMS) amplitude attribute is calculated by computing the square root of the arithmetic mean of the squares of the seismic amplitude values. Higher RMS amplitude corresponds to more porous rocks, such as the vugular geobodies.

The variance attribute is used to image geological discontinuities, such as the vugular geobodies. Variance is calculated by applying an algorithm to compute the local variance of the seismic data. In examples, variance is considered an edge detection technique that images the discontinuities of seismic data related to stratigraphic features. Thus, variance is applicable to guide vugular geobodies detection as they can correspond to some discontinuities in seismic data.

The envelope attribute is a representation of instantaneous amplitudes of seismic data. It is computed by extracting the absolute values of seismic traces. The envelope attribute similar to variance, the envelope attribute is used to image stratigraphic discontinuities such as the vugular geobodies.

The frequency attribute represents frequency values of seismic data. It is used to define stratigraphic features, such as distributions of lithology. The frequency attribute is utilized to define the distribution of stratigraphic features, such as vugular geobodies. In examples, the vugular geobodies are defined in three dimensions (x, y, and z).

The spectral decomposition attribute is computed by separating seismic data into selected frequency ranges. In examples, the Fourier transform algorithm is applied to seismic data, and amplitude values in respective frequency ranges are extracted to calculate the spectral decomposition attribute.

At least one or any combination of the attributes are conditioned and incorporated as input data into the machine learning processes. In examples, conditioning refers to calibrating or re-distributing the seismic attributes into 3D geocellular properties. Geometric resampling is applied to the respective seismic attributes to determine seismic attribute values for each cell of a 3D geomodel. In some embodiments, seismic attributes are averaged to represent a respective cells of the 3D geomodel. Each cell within the 3D geomodel corresponds to a seismic value derived from a calculated seismic attribute.

At block 106, geologically high resolution 3D property generation using a first machine learning process is performed. At block 108, 3D vugular geobodies are predicted based on the predefined high resolution 3D properties using a second machine learning process. In examples, a first trained machine learning model generates at least one geologically high resolution 3D property. The first trained machine learning model learns to corroborate the multi-seismic attributes to generate at least one geologically high resolution 3D property. In examples, a second trained machine learning model predicts 3D vugular geobodies based on the at least one geologically high resolution 3D property. The second trained machine learning model learns to predict 3D vugular geobodies based on the at least one geologically high resolution 3D property and 1D vugular flag logs incorporated as the training data as well as for the prediction target. In some embodiments, the trained machine learning models are based on an Extreme Gradient Boost (XGB) algorithm, a Neural Network (NN) algorithm, or any combinations thereof.

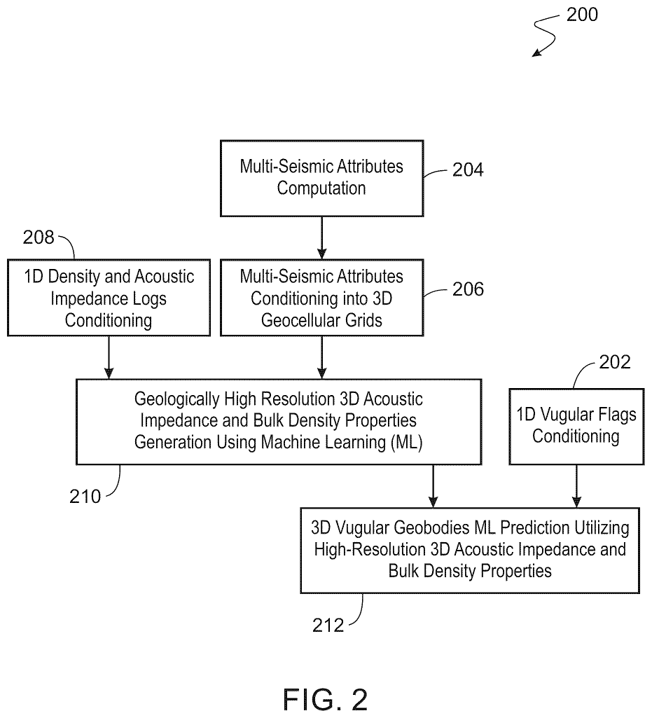

FIG. 2 shows 3D vugular property modeling with derived high resolution 3D properties using a geologically high-resolution machine learning workflow 200. The first stage of the GHREM workflow 200 is to generate the high-resolution acoustic impedance and high-resolution density properties. In some embodiments, the high-resolution acoustic impedance and high-resolution density properties are generated by a first machine learning model. The second stage of the GHREM workflow is to generate the 3D vugular geobody predictions using the high-resolution acoustic impedance and high-resolution density properties.

At block 202, 1D vugular interval conditioning is performed. Similar to block 102 of FIG. 1, at block 202 1D vugular intervals conditioning involves conversions of discrete vugular flags into continuous log domain. The continuous vugular logs are also resampled into 0.2 ft resolution to increase the number of samples for more accurate machine learning predictions.

At block 204, multiple seismic attributes are computed in parallel with 1D vugular interval conditioning. The resampled seismic attributes (e.g., resampled quadrature, acoustic impedance, RMS, variance, envelope, frequency and spectral decomposition) are utilized as input data to the first machine learning process that estimates a high-resolution 3D acoustic impedance property and a high-resolution bulk density volume.

At block 206, the multiple seismic attributes are conditioned into 3D geocellular grids. The conditioning at block 206 is similar to or the same as the conditioning as described at block 104 of FIG. 1. At block 208, 1D density logs and acoustic impedance logs are conditioned. The conditioning at block 208 is similar to or the same as the conditioning as described at block 102 of FIG. 1. In some embodiments, the multiple seismic attributes are conditioned into 3D geocellular grids, and conditioned 1D density logs and conditioned acoustic impedance logs are used to train a first machine learning model to generate geologically high resolution 3D acoustic impedance properties and bulk density properties. Once trained, the first trained machine learning model obtains multiple seismic attributes as input and outputs geologically high resolution 3D acoustic impedance properties and bulk density properties. Accordingly, at block 210 geologically high resolution 3D acoustic impedance properties and bulk density property generation is performed using a first trained machine learning model.

The first machine learning model is to estimate a high-resolution 3D acoustic impedance property. In examples, well-based acoustic impedance logs are used as the training data and prediction target to ensure a high-resolution acoustic impedance is generated by corroborating 3D multi-seismic attributes and well-resolution acoustic impedance logs. In some embodiments, machine learning realizations such as XGB & NN algorithms, are used to enrich the input data. Ultimately, this high-resolution attribute yields more accurate and geologically realistic prediction of the vugular properties.

The first machine learning model also estimates a high-resolution bulk density volume. This geologically high-resolution bulk density volume is also estimated in the machine learning process using the set of multiple seismic attributes: quadrature, acoustic impedance, RMS, variance, envelope, frequency and spectral decomposition, or any combinations thereof. High-resolution bulk density well logs are used as the training data and prediction target of the machine learning process. Machine learning realizations such as XGB & NN algorithms are also used to enrich the input data.

In examples, machine learning realizations are automated (computer-based) predictions performed using machine learning algorithms, such as Extreme Gradient Boost (XGB) and Neural Network (NN) algorithms by incorporating 3D seismic attributes and well logs as input data. Four machine learning realizations were executed, respectively, using XGB and NN algorithm to enrich the input data for subsequent machine learning modeling (e.g., 3D vugular property modeling).

At block 212, 3D vugular geobodies are predicted using a second machine learning model and high resolution 3D acoustic impedance properties and bulk density properties. A combination of high-resolution acoustic impedance volumes and density volumes are used as the input of the GHREM workflow to predict the 3D vugular geobodies. Continuous vugular flag logs are used as the training data and prediction target. The continuous vugular flag logs are resampled into 0.2 ft resolution to increase sample numbers to enhance prediction accuracy. In examples, the second machine learning model is based on algorithms such as Random Forest (RF), XGB and NN.

In the second machine learning process, GHREM-based predictions are used as input data for the 3D vugular property modeling. In examples, four machine learning realizations are executed utilizing XGB and NN algorithm respectively. This process provides a total of eight (8) high-resolution 3D acoustic impedance properties and eight (8) high-resolution 3D bulk density properties, as the input for the subsequent machine learning process to estimate the final 3D vugular property. In examples, the high-resolution inputs yield an approximately 86% accurate 3D vugular property prediction.

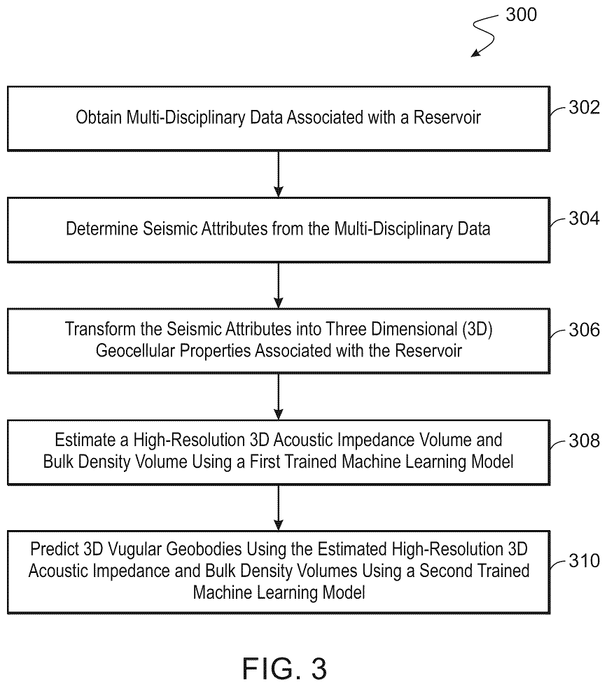

FIG. 3 is a process flow diagram of a process 300 that enables vugular property modeling using geologically high-resolution machine learning.

At block 302, multi-disciplinary data associated with a reservoir is obtained.

At block 304, seismic attributes are determined from the multi-disciplinary data. In examples, multi-disciplinary data includes well-logs, one dimensional (1D) discrete vugular flags, seismic attributes, and high-resolution 3D property volumes (e.g., acoustic impedance and density).

At block 306, the seismic attributes are transformed into three dimensional (3D) geocellular properties associated with the reservoir. In examples, 3D gridded data includes cells that correspond to respective locations and are associated with at least one seismic attribute value.

At block 308, 3D property volumes are estimated. In examples, the 3D properties are estimated using a first machine learning model. In examples, the 3D properties are a high-resolution 3D acoustic impedance volume and high-resolution 3D bulk density volume using a first trained machine learning model, wherein the first trained machine learning model obtains the 3D geocellular properties as input and outputs high-resolution 3D acoustic impedance volumes and bulk density volumes. In some embodiments, high-resolution 3D acoustic impedance and density volumes are generated that yield a much higher resolution data compared to the original seismic resolution. This improves the accuracy of 3D vugular geobody predictions.

At block 310, 3D vugular geobodies are predicted using the 3D property volumes. For example, 3D vugular geobodies are estimated based on high-resolution 3D acoustic impedance and high-resolution 3D bulk density volumes using a second trained machine learning model, wherein the second trained machine learning model obtains the high-resolution 3D acoustic impedance and bulk density volumes and outputs predicted 3D vugular geobodies. In some embodiments, the predicted 3D vugular geobodies form a 3D vugular property model. The present systems and techniques enable faster modeling of 3D vugular properties, and are more comprehensive than traditional 3D modeling. Additionally, the present systems and techniques do not use traditional vertical and lateral variogram analyses. Rather, the present techniques capture these features automatically in the machine learning predictions.

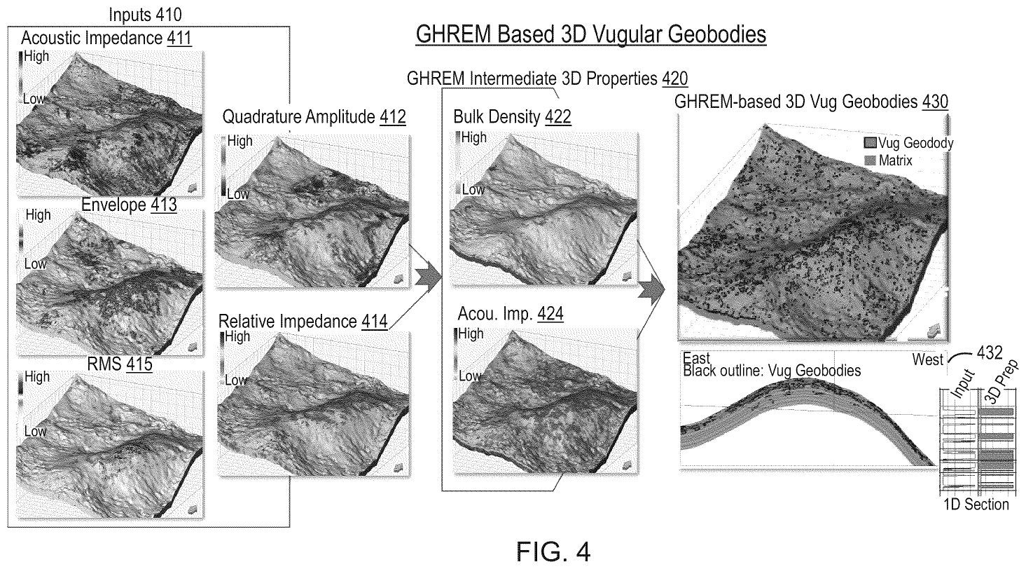

FIG. 4 is a rendering 400 of 3D volumes including 3D vugular geobodies. In the example of FIG. 4, inputs 410 to a workflow that models vugular properties are shown. The inputs 410 include seismic attributes such as acoustic impedance 411, quadrature amplitude 412, envelope 413, relative impedance 414, and root mean square (RMS) amplitude 415.

The inputs 410 are used to determine intermediate properties 420. In the example of FIG. 4, the intermediate geologically high-resolution 3D properties are a high-resolution bulk density property volume 422 and a high-resolution acoustic impedance volume 424. The generation of these intermediate geologically high-resolution 3D properties improves the accuracy of vugular geobody spatial and temporal distributions. The geologically realistic vugular geobodies yield more accurate reservoir quality predictions and volume estimations in vuggy carbonate reservoirs. A 3D vugular geobodies are shown in the 3D property volume 430 of FIG. 4. A bird's eye view of the vugular geobodies is shown at reference number 432.

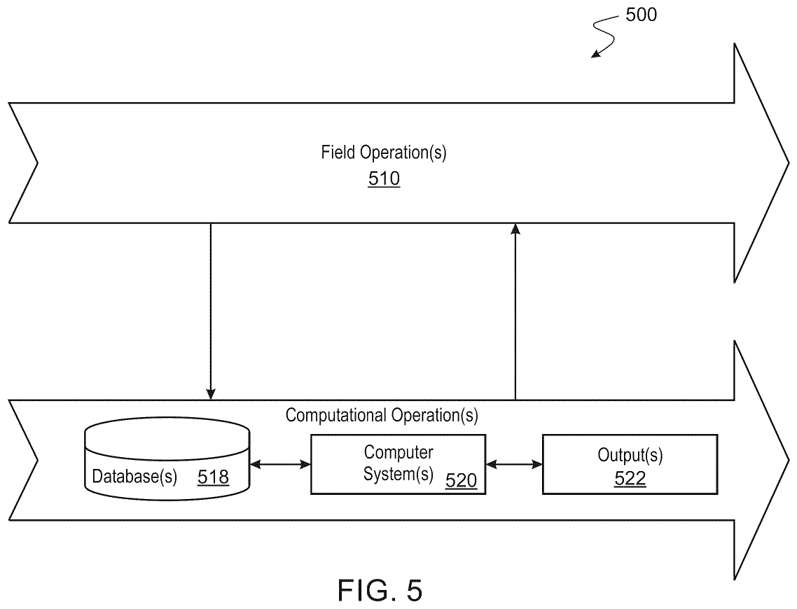

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

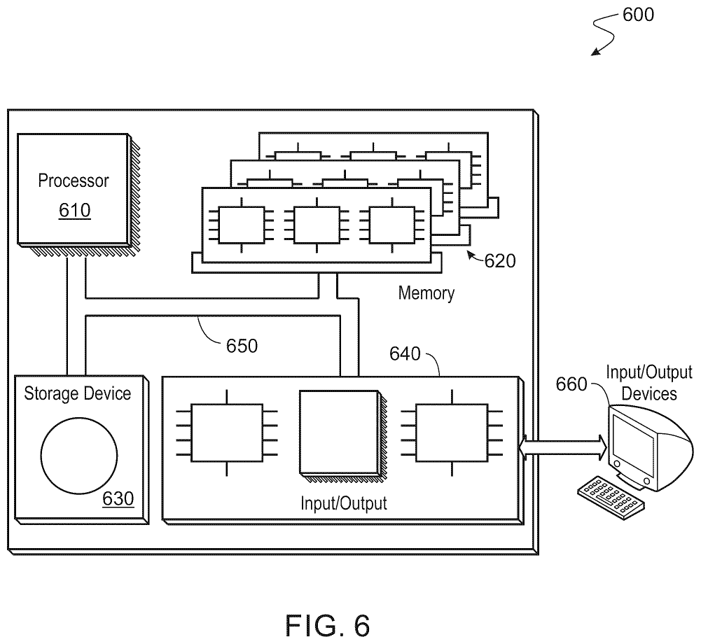

FIG. 6 is a schematic illustration of an example controller 600 (or control system) that enables property modeling using geologically high-resolution machine learning. For example, the controller 600 may be operable according to the workflow 100 of FIG. 1, workflow 200 of FIG. 2, or the process 300 of FIG. 3. In some embodiments, the controller 600 is the same as or similar to the computer systems 520 of FIG. 5. The controller 600 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output interface 640 communicatively coupled with input/output devices 660 (for example, displays, keyboards, measurement devices, sensors, valves, pumps). Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output interface 640.

The memory 620 stores information within the controller 600. In one implementation, the memory 620 is a computer-readable medium. In one implementation, the memory 620 is a volatile memory unit. In another implementation, the memory 620 is a nonvolatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output interface 640 provides input/output operations for the controller 600. In one implementation, the input/output devices 660 includes a keyboard and/or pointing device. In another implementation, the input/output devices 660 includes a display unit for displaying graphical user interfaces.

There can be any number of controllers 600 associated with, or external to, a computer system containing controller 600, with each controller 600 communicating over a network. Further, the terms “client,” “user,” and other appropriate terminology can be used interchangeably, as appropriate, without departing from the scope of the present disclosure. Moreover, the present disclosure contemplates that many users can use one controller 600 and one user can use multiple controllers 600.

### Embodiments

According to some non-limiting embodiments or examples, provided is a computer-implemented method that enables vugular property modeling using geologically high-resolution machine learning, including: obtaining, using at least one hardware processor, multi-disciplinary data associated with a reservoir; determining, using the at least one hardware processor, seismic attributes from the multi-disciplinary data; transforming, using the at least one hardware processor, the seismic attributes into three dimensional (3D) geocellular properties associated with the reservoir; estimating, using the at least one hardware processor, a high-resolution 3D acoustic impedance volume and bulk density volume using a first trained machine learning model, wherein the first trained machine learning model obtains the 3D geocellular properties as input and outputs high-resolution 3D acoustic impedance and bulk density volumes; and predicting, using the at least one hardware processor, 3D vugular geobodies using the estimated high-resolution 3D acoustic impedance and bulk density volumes using a second trained machine learning model, wherein the second trained machine learning model obtains the high-resolution 3D acoustic impedance and bulk density volumes and outputs predicted 3D vugular geobodies.

According to some non-limiting embodiments or examples, provided is an apparatus including a non-transitory, computer readable, storage medium that stores instructions that, when executed by at least one processor, cause the at least one processor to perform operations including: obtaining multi-disciplinary data associated with a reservoir; determining seismic attributes from the multi-disciplinary data; transforming the seismic attributes into three dimensional (3D) geocellular properties associated with the reservoir; estimating a high-resolution 3D acoustic impedance volume and bulk density volume using a first trained machine learning model, wherein the first trained machine learning model obtains the 3D geocellular properties as input and outputs high-resolution 3D acoustic impedance and bulk density volumes; and predicting 3D vugular geobodies using the estimated high-resolution 3D acoustic impedance and bulk density volumes using a second trained machine learning model, wherein the second trained machine learning model obtains the high-resolution 3D acoustic impedance and bulk density volumes and outputs predicted 3D vugular geobodies.

According to some non-limiting embodiments or examples, provided is a system, including: one or more memory modules; one or more hardware processors communicably coupled to the one or more memory modules, the one or more hardware processors configured to execute instructions stored on the one or more memory models to perform operations including: obtaining multi-disciplinary data associated with a reservoir; determining seismic attributes from the multi-disciplinary data; transforming the seismic attributes into three dimensional (3D) geocellular properties associated with the reservoir; estimating a high-resolution 3D acoustic impedance volume and bulk density volume using a first trained machine learning model, wherein the first trained machine learning model obtains the 3D geocellular properties as input and outputs high-resolution 3D acoustic impedance and bulk density volumes; and predicting 3D vugular geobodies using the estimated high-resolution 3D acoustic impedance and bulk density volumes using a second trained machine learning model, wherein the second trained machine learning model obtains the high-resolution 3D acoustic impedance and bulk density volumes and outputs predicted 3D vugular geobodies.

Further non-limiting aspects or embodiments are set forth in the following numbered embodiments:

Embodiment 1: A computer-implemented method that enables vugular property modeling using geologically high-resolution machine learning, including: obtaining, using at least one hardware processor, multi-disciplinary data associated with a reservoir; determining, using the at least one hardware processor, seismic attributes from the multi-disciplinary data; transforming, using the at least one hardware processor, the seismic attributes into three dimensional (3D) geocellular properties associated with the reservoir; estimating, using the at least one hardware processor, a high-resolution 3D acoustic impedance volume and bulk density volume using a first trained machine learning model, wherein the first trained machine learning model obtains the 3D geocellular properties as input and outputs high-resolution 3D acoustic impedance and bulk density volumes; and predicting, using the at least one hardware processor, 3D vugular geobodies using the estimated high-resolution 3D acoustic impedance and bulk density volumes using a second trained machine learning model, wherein the second trained machine learning model obtains the high-resolution 3D acoustic impedance and bulk density volumes and outputs predicted 3D vugular geobodies.

Embodiment 2: The computer implemented method of any of the preceding embodiments, wherein the multi-disciplinary data includes well-logs, 1D discrete vugular flags, basic seismic attributes and high-resolution 3D property volumes.

Embodiment 3: The computer implemented method of any of the preceding embodiments, wherein the first trained machine learning model is trained using resampled seismic attributes, high resolution acoustic impedance logs, and high resolution bulk density well logs.

Embodiment 4: The computer implemented method of any of the preceding embodiments, wherein the second trained machine learning model is trained using continuous vugular flag logs, high resolution acoustic impedance logs, and high resolution bulk density well logs.

Embodiment 5: The computer implemented method of any of the preceding embodiments, wherein transforming the seismic attributes into three dimensional (3D) geocellular properties associated with the reservoir includes generating 3D gridded data by evaluating respective seismic attributes associated with each cell and modifying or retaining the respective seismic attributes based on a predetermined series of rules.

Embodiment 6: The computer implemented method of any of the preceding embodiments, wherein the seismic attributes include at least one of acoustic impedance, quadrature amplitude, Root Mean Square (RMS) amplitude, variance, frequency, envelope and spectrally decomposed attributes.

Embodiment 7: The computer implemented method of any of the preceding embodiments, wherein the seismic attributes are transformed into the 3D geocellular properties associated with the reservoir using at least one trained machine learning model.

Embodiment 8: An apparatus including a non-transitory, computer readable, storage medium that stores instructions that, when executed by at least one processor, cause the at least one processor to perform operations including: obtaining multi-disciplinary data associated with a reservoir; determining seismic attributes from the multi-disciplinary data; transforming the seismic attributes into three dimensional (3D) geocellular properties associated with the reservoir; estimating a high-resolution 3D acoustic impedance volume and bulk density volume using a first trained machine learning model, wherein the first trained machine learning model obtains the 3D geocellular properties as input and outputs high-resolution 3D acoustic impedance and bulk density volumes; and predicting 3D vugular geobodies using the estimated high-resolution 3D acoustic impedance and bulk density volumes using a second trained machine learning model, wherein the second trained machine learning model obtains the high-resolution 3D acoustic impedance and bulk density volumes and outputs predicted 3D vugular geobodies.

Embodiment 9: The apparatus of any of the preceding embodiments, wherein the multi-disciplinary data includes well-logs, 1D discrete vugular flags, basic seismic attributes and high-resolution 3D property volumes.

Embodiment 10: The apparatus of any of the preceding embodiments, wherein the first trained machine learning model is trained using resampled seismic attributes, high resolution acoustic impedance logs, and high resolution bulk density well logs.

Embodiment 11: The apparatus of any of the preceding embodiments, wherein the second trained machine learning model is trained using continuous vugular flag logs, high resolution acoustic impedance logs, and high resolution bulk density well logs.

Embodiment 12: The apparatus of any of the preceding embodiments, wherein transforming the seismic attributes into three dimensional (3D) geocellular properties associated with the reservoir includes generating 3D gridded data by evaluating respective seismic attributes associated with each cell and modifying or retaining the respective seismic attributes based on a predetermined series of rules.

Embodiment 13: The apparatus of any of the preceding embodiments, wherein the seismic attributes include at least one of acoustic impedance, quadrature amplitude, Root Mean Square (RMS) amplitude, variance, frequency, envelope and spectrally decomposed attributes.

Embodiment 14: The apparatus of any of the preceding embodiments, wherein the seismic attributes are transformed into the 3D geocellular properties associated with the reservoir using at least one trained machine learning model.

Embodiment 15: A system, including: one or more memory modules; one or more hardware processors communicably coupled to the one or more memory modules, the one or more hardware processors configured to execute instructions stored on the one or more memory models to perform operations including: obtaining multi-disciplinary data associated with a reservoir; determining seismic attributes from the multi-disciplinary data; transforming the seismic attributes into three dimensional (3D) geocellular properties associated with the reservoir; estimating a high-resolution 3D acoustic impedance volume and bulk density volume using a first trained machine learning model, wherein the first trained machine learning model obtains the 3D geocellular properties as input and outputs high-resolution 3D acoustic impedance and bulk density volumes; and predicting 3D vugular geobodies using the estimated high-resolution 3D acoustic impedance and bulk density volumes using a second trained machine learning model, wherein the second trained machine learning model obtains the high-resolution 3D acoustic impedance and bulk density volumes and outputs predicted 3D vugular geobodies.

Embodiment 16: The system of any of the preceding embodiments, wherein the multi-disciplinary data includes well-logs, 1D discrete vugular flags, basic seismic attributes and high-resolution 3D property volumes.

Embodiment 17: The system of any of the preceding embodiments, wherein the first trained machine learning model is trained using resampled seismic attributes, high resolution acoustic impedance logs, and high resolution bulk density well logs.

Embodiment 18: The system of any of the preceding embodiments, wherein the second trained machine learning model is trained using continuous vugular flag logs, high resolution acoustic impedance logs, and high resolution bulk density well logs.

Embodiment 19: The system of any of the preceding embodiments, wherein transforming the seismic attributes into three dimensional (3D) geocellular properties associated with the reservoir includes generating 3D gridded data by evaluating respective seismic attributes associated with each cell and modifying or retaining the respective seismic attributes based on a predetermined series of rules.

Embodiment 20: The system of any of the preceding embodiments, wherein the seismic attributes include at least one of acoustic impedance, quadrature amplitude, Root Mean Square (RMS) amplitude, variance, frequency, envelope and spectrally decomposed attributes.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method that enables vugular property modeling using geologically high-resolution machine learning, comprising:
obtaining, using at least one hardware processor, multi-disciplinary data associated with a reservoir;
determining, using the at least one hardware processor, seismic attributes from the multi-disciplinary data;
transforming, using the at least one hardware processor, the seismic attributes into three dimensional (3D) geocellular properties associated with the reservoir;
estimating, using the at least one hardware processor, a high-resolution 3D acoustic impedance volume and bulk density volume using a first trained machine learning model, wherein the first trained machine learning model obtains the 3D geocellular properties as input and outputs high-resolution 3D acoustic impedance and bulk density volumes; and
predicting, using the at least one hardware processor, 3D vugular geobodies using the estimated high-resolution 3D acoustic impedance and bulk density volumes using a second trained machine learning model, wherein the second trained machine learning model obtains the high-resolution 3D acoustic impedance and bulk density volumes and outputs predicted 3D vugular geobodies.

2. The computer implemented method of claim 1, wherein the multi-disciplinary data comprises well-logs, 1D discrete vugular flags, basic seismic attributes and high-resolution 3D property volumes.

3. The computer implemented method of claim 1, wherein the first trained machine learning model is trained using resampled seismic attributes, high resolution acoustic impedance logs, and high resolution bulk density well logs.

4. The computer implemented method of claim 1, wherein the second trained machine learning model is trained using continuous vugular flag logs, high resolution acoustic impedance logs, and high resolution bulk density well logs.

5. The computer implemented method of claim 1, wherein transforming the seismic attributes into three dimensional (3D) geocellular properties associated with the reservoir comprises generating 3D gridded data by evaluating respective seismic attributes associated with each cell and modifying or retaining the respective seismic attributes based on a predetermined series of rules.

6. The computer implemented method of claim 1, wherein the seismic attributes comprise at least one of acoustic impedance, quadrature amplitude, Root Mean Square (RMS) amplitude, variance, frequency, envelope and spectrally decomposed attributes.

7. The computer implemented method of claim 1, wherein the seismic attributes are transformed into the 3D geocellular properties associated with the reservoir using at least one trained machine learning model.

8. An apparatus comprising a non-transitory, computer readable, storage medium that stores instructions that, when executed by at least one processor, cause the at least one processor to perform operations comprising:
obtaining multi-disciplinary data associated with a reservoir;
determining seismic attributes from the multi-disciplinary data;
transforming the seismic attributes into three dimensional (3D) geocellular properties associated with the reservoir;
estimating a high-resolution 3D acoustic impedance volume and bulk density volume using a first trained machine learning model, wherein the first trained machine learning model obtains the 3D geocellular properties as input and outputs high-resolution 3D acoustic impedance and bulk density volumes; and
predicting 3D vugular geobodies using the estimated high-resolution 3D acoustic impedance and bulk density volumes using a second trained machine learning model, wherein the second trained machine learning model obtains the high-resolution 3D acoustic impedance and bulk density volumes and outputs predicted 3D vugular geobodies.

9. The apparatus of claim 8, wherein the multi-disciplinary data comprises well-logs, 1D discrete vugular flags, basic seismic attributes and high-resolution 3D property volumes.

10. The apparatus of claim 8, wherein the first trained machine learning model is trained using resampled seismic attributes, high resolution acoustic impedance logs, and high resolution bulk density well logs.

11. The apparatus of claim 8, wherein the second trained machine learning model is trained using continuous vugular flag logs, high resolution acoustic impedance logs, and high resolution bulk density well logs.

12. The apparatus of claim 8, wherein transforming the seismic attributes into three dimensional (3D) geocellular properties associated with the reservoir comprises generating 3D gridded data by evaluating respective seismic attributes associated with each cell and modifying or retaining the respective seismic attributes based on a predetermined series of rules.

13. The apparatus of claim 8, wherein the seismic attributes comprise at least one of acoustic impedance, quadrature amplitude, Root Mean Square (RMS) amplitude, variance, frequency, envelope and spectrally decomposed attributes.

14. The apparatus of claim 8, wherein the seismic attributes are transformed into the 3D geocellular properties associated with the reservoir using at least one trained machine learning model.

15. A system, comprising:
one or more memory modules;
one or more hardware processors communicably coupled to the one or more memory modules, the one or more hardware processors configured to execute instructions stored on the one or more memory models to perform operations comprising:
obtaining multi-disciplinary data associated with a reservoir;
determining seismic attributes from the multi-disciplinary data;
transforming the seismic attributes into three dimensional (3D) geocellular properties associated with the reservoir;
estimating a high-resolution 3D acoustic impedance volume and bulk density volume using a first trained machine learning model, wherein the first trained machine learning model obtains the 3D geocellular properties as input and outputs high-resolution 3D acoustic impedance and bulk density volumes; and
predicting 3D vugular geobodies using the estimated high-resolution 3D acoustic impedance and bulk density volumes using a second trained machine learning model, wherein the second trained machine learning model obtains the high-resolution 3D acoustic impedance and bulk density volumes and outputs predicted 3D vugular geobodies.

16. The system of claim 15, wherein the multi-disciplinary data comprises well-logs, 1D discrete vugular flags, basic seismic attributes and high-resolution 3D property volumes.

17. The system of claim 15, wherein the first trained machine learning model is trained using resampled seismic attributes, high resolution acoustic impedance logs, and high resolution bulk density well logs.

18. The system of claim 15, wherein the second trained machine learning model is trained using continuous vugular flag logs, high resolution acoustic impedance logs, and high resolution bulk density well logs.

19. The system of claim 15, wherein transforming the seismic attributes into three dimensional (3D) geocellular properties associated with the reservoir comprises generating 3D gridded data by evaluating respective seismic attributes associated with each cell and modifying or retaining the respective seismic attributes based on a predetermined series of rules.

20. The system of claim 15, wherein the seismic attributes comprise at least one of acoustic impedance, quadrature amplitude, Root Mean Square (RMS) amplitude, variance, frequency, envelope and spectrally decomposed attributes.
